(19) United States
(12) Patent Application Publication
(10) Pub. No.: US 2022/0142146 A1
(43) Pub. Date: May 12, 2022

(54) MODULAR HUNTING BLIND

(71) Applicant: Orion Hunting Products, LLC, Iron Mountain, MI (US)

(72) Inventors: Beau Anderson, Norway, MI (US); Cole Welch, Kingsford, MI (US)

(73) Assignee: Orion Hunting Products, LLC, Iron Mountain, MI (US)

(21) Appl. No.: 17/412,703

(22) Filed: Aug. 26, 2021

Related U.S. Application Data
(60) Provisional application No. 63/070,405, filed on Aug. 26, 2020.

(51) Int. Cl. A01M 31/02; E04H 15/00

(52) U.S. Cl. CPC A01M 31/025; E04H 15/008; E04H 15/001

(57) ABSTRACT

A hunting blind is used for shielding a hunter while allowing the hunter to view and aim a weapon at the hunting target. The hunting blind may include a plurality of panels of the same or different sizes. Each panel may include at least one latch mating element and/or a latch. For assembly, the plurality of panels are placed adjacent to one another with portions of the adjoining panels overlapping. Each latch mating element included on a particular panel corresponds to a latch on an adjacent panel so that the panels can be secured in position.

### CROSS-REFERENCE AND PRIORITY CLAIM

This application is based on U.S. Provisional Patent Application Ser. No. 63/070,405 filed on Aug. 26, 2020, to which priority is claimed and the disclosure of which is incorporated herein by reference for all purposes.

### FIELD OF THE INVENTION

The present invention relates generally to the field of hunting blinds. More particularly, the present invention relates to modular hunting blinds, the modular panels of which connect with a latching mechanism.

### BACKGROUND

A temporary hunting blind requires a degree of portability and ease of assembly that allows a hunter to transport the blind to the desired hunting location, assemble the blind, and then disassemble, transport, and store the blind when the hunting endeavor is complete. One existing solution is to use a tent-like structure with fabric sides and poles or ropes for support although such structures provide only minimal protection from the elements and are not very durable. Currently, temporary hard wall hunting blinds also exist that may be constructed and deconstructed on site. However, the panels of such temporary structures are typically connected with nuts and bolts and/or screws, requiring additional tools for construction and deconstruction, which adds to the list of items that must be transported to the hunting site and the complexity of assembly and disassembly. And such hard wall blinds typically require the use of heavy equipment or tractors to transport and lift the blind to an elevated position. Further, even upon deconstruction, certain of these hunting blinds are not easily stored or transported, even in deconstructed form.

As such, there is a need for an improved hunting blind that may easily be assembled and disassembled into a form that is conveniently transportable and storable, without requiring the use of additional tools. There is further a need for such a structure that can be sealed against air drafts.

It will be understood by those skilled in the art that one or more aspects of this invention can meet certain objectives, while one or more other aspects can lead to certain other objectives. Other objects, features, benefits and advantages of the present invention will be apparent in this summary and descriptions of the disclosed embodiment, and will be readily apparent to those skilled in the art. Such objects, features, benefits and advantages will be apparent from the above as taken in conjunction with the accompanying figures and all reasonable inferences to be drawn therefrom.

### BRIEF DESCRIPTION OF THE DRAWINGS

FIG. 1 is a top perspective view of an assembled modular hunting blind in accordance with one embodiment of the present invention;

FIG. 2 is a bottom perspective view of the blind of FIG. 1;

FIG. 3 is a front view of the blind of FIG. 1;

FIG. 4 is a rear view of the blind of FIG. 1;

FIG. 5 is a top view of the blind of FIG. 1;

FIG. 6 is a bottom view of the blind of FIG. 1;

FIG. 7 is a bottom perspective view of an assembled modular hunting blind in accordance with another embodiment of the invention, positioned on a hunting stand base;

FIG. 8 is a bottom perspective view of an assembled modular hunting blind in accordance with another embodiment of the invention, positioned on a hunting stand base;

FIG. 9 is an interior perspective view of the latched connection between modular panels of the blind of FIG. 1;

FIG. 10 is a detail view showing Section 10-10 of FIG. 9;

FIG. 11 is a detail view showing Section 11-11 of FIG. 9;

FIG. 12 is a detail view showing Section 12-12 of FIG. 9;

FIG. 13 is a front view of the top panels of the blind of FIG. 1;

FIG. 14 is a perspective view of the latch shown in FIG. 10, with the first connecting flange removed for clarity;

FIG. 15 is another perspective view of the latch shown in FIG. 10, with the first connecting flange removed for clarity;

FIG. 16 is a bottom perspective view of the top panels shown in FIG. 13;

FIG. 17 is a bottom view of the top panels shown in FIG. 13;

FIG. 18 is a perspective view of the latch shown in FIG. 12, with the first connecting flange removed for clarity;

FIG. 19 is another perspective view of the latch shown in FIG. 12, with the first connecting flange removed for clarity;

FIG. 20 is a top perspective view of the bottom panels of the blind of FIG. 1;

FIG. 21 is a top view of the bottom panels shown in FIG. 20;

FIG. 22 is a front view of the bottom panels shown in FIG. 20;

FIG. 23 is a perspective view of the interior of the assembled hunting blind of FIG. 1;

FIG. 24 is a detail perspective view of a latch connection between two of the side panels of the blind shown in FIG. 23;

FIG. 25 is a detail top view of two side panels prior to assembly, in accordance with one embodiment of the present invention;

FIG. 26 is a detail top perspective view of the overlapping elements of the two side panels shown in FIG. 25 arranged in an assembled position;

FIG. 27 is a top perspective view of portions of the hunting blind shown in FIG. 23 in packaged and disassembled form;

FIG. 28 is another a top perspective view of portions of the hunting blind shown in FIG. 23 in packaged and disassembled form;

FIG. 29 is a perspective view of a deconstructed set of modular panels of the blind of FIG. 27;

FIG. 30 is a top perspective view of the disassembled blind of FIG. 27 stored in a truck bed; and

FIG. 31 is another top perspective view of the disassembled blind of FIG. 27 stored in a truck bed.

### DETAILED DESCRIPTION

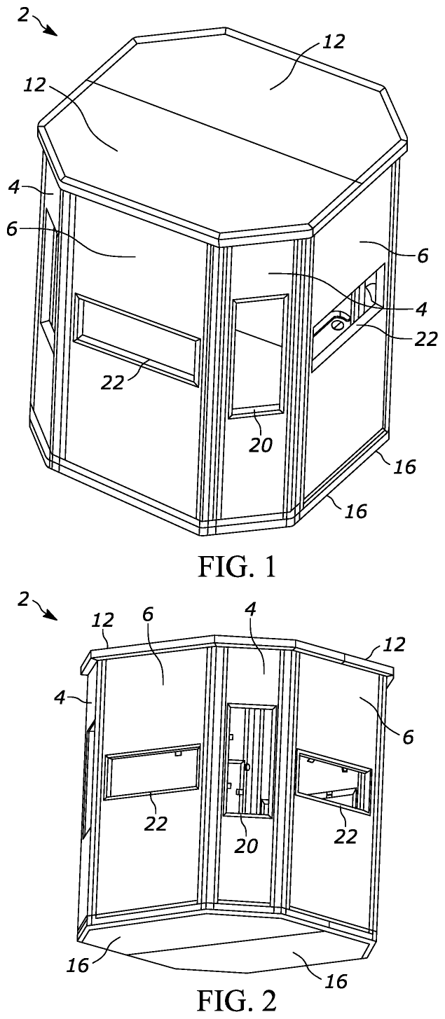

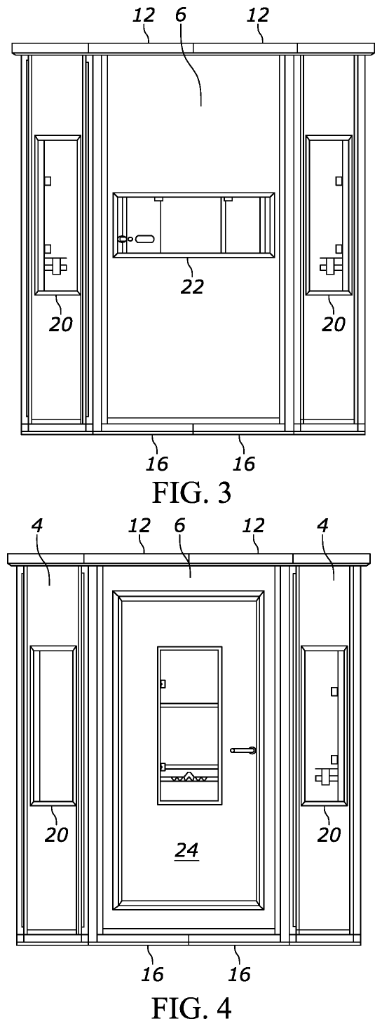

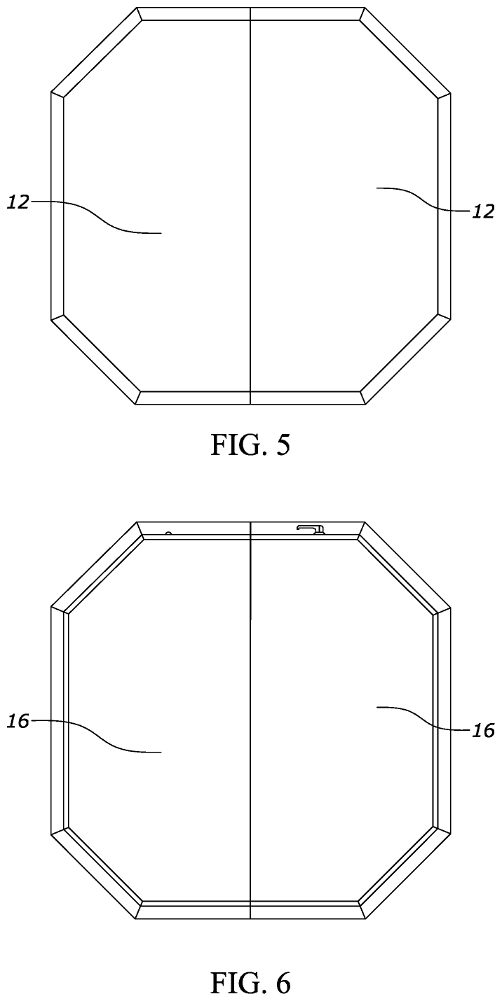

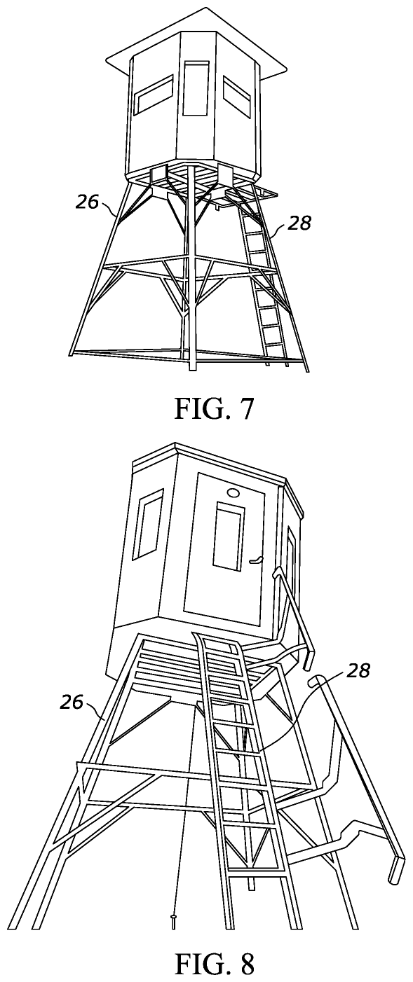

FIGS. 1-6 show one embodiment of a modular hunting blind 2, in accordance with the present invention. The modular hunting blind 2 shown in this embodiment is octagonal in shape, with four narrower side panels 4 and four wider side panels 6 alternating with the narrower side panels 4. In alternative embodiments, the modular hunting blind may include a different number of sides, e.g., 4, 5, 6, 10, etc., forming a different shape. The side panels 4, 6 may also vary in proportional width, and may include more or fewer than two standard widths. A top panel or panels and a bottom panel or panels may be positioned above and below the side panels 4, 6. In the illustrated embodiment, two top panels 12 are connectible to the side panels 4, 6 and two bottom panels 16 are connectible to opposite sides of the side panels 4,6. While varying numbers of top and bottom panels may be used without departing from the spirit of this invention, the use of two top panels 12 and two bottom panels 16 optimizes ease of assembly by providing panels of readily maneuverable size and weight, without generating so many separate panels as to make assembly tedious. While in some embodiments, such as the embodiment shown in FIGS. 1-6, the top panels 12 and bottom panels 16 may mimic the overall pentagonal shape of a given blind, in other embodiments the assembled shape of the top panels may differ, as illustrated in FIG. 7.

The side panels 4, 6 may include narrower windows 20 and/or wider windows 22 through which to view animals below and/or aim a hunting weapon. At least one side panel 4,6 may include a door 24 for entry into and exit from the blind 2. As shown in FIGS. 7-8, the hunting blind may be positioned on a base 26, with a ladder 28, or other form of stepping mechanism, such as a set of stairs, leading up to the door.

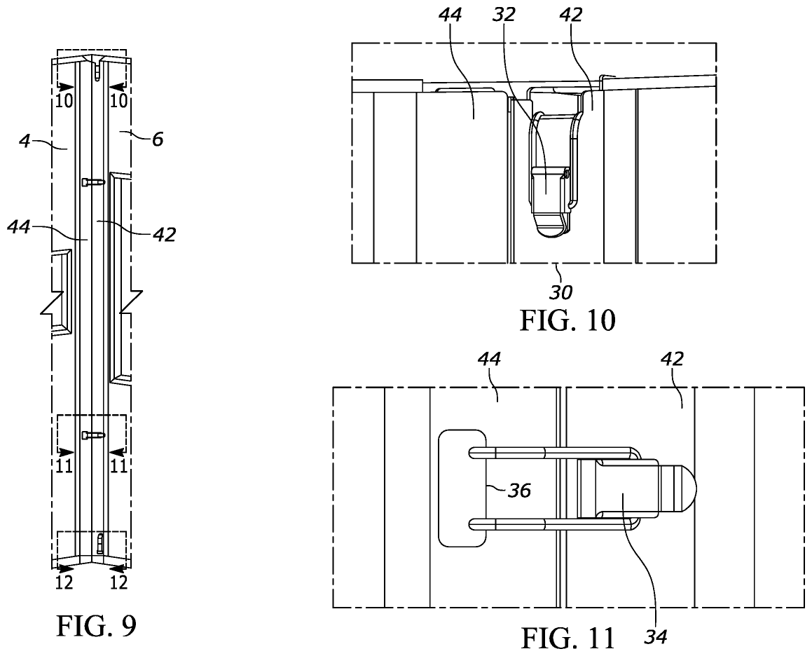

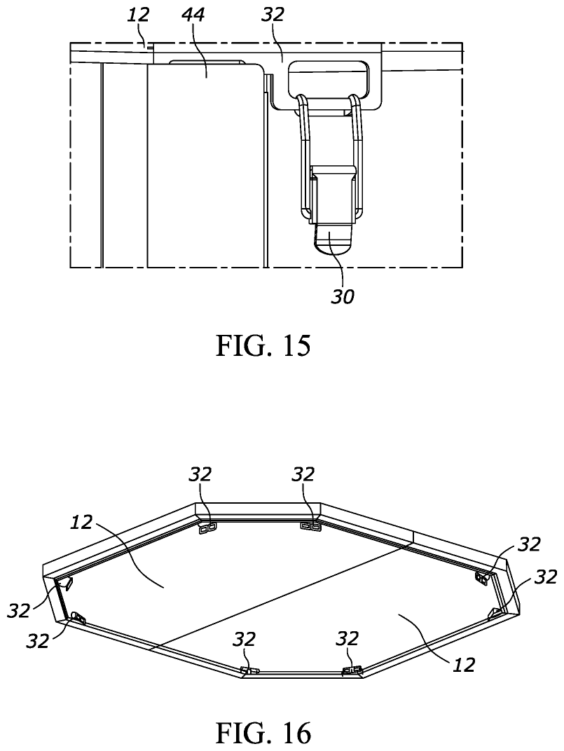

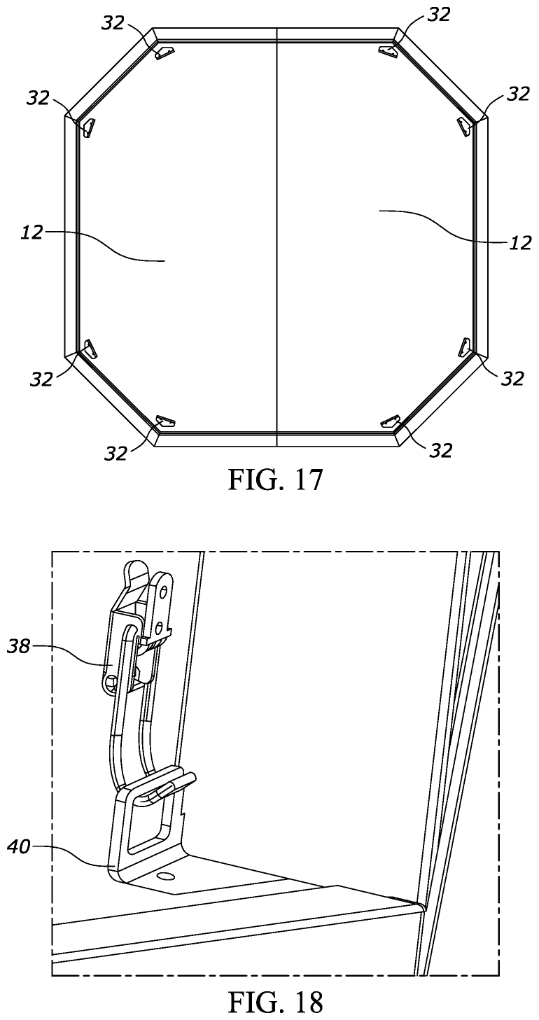

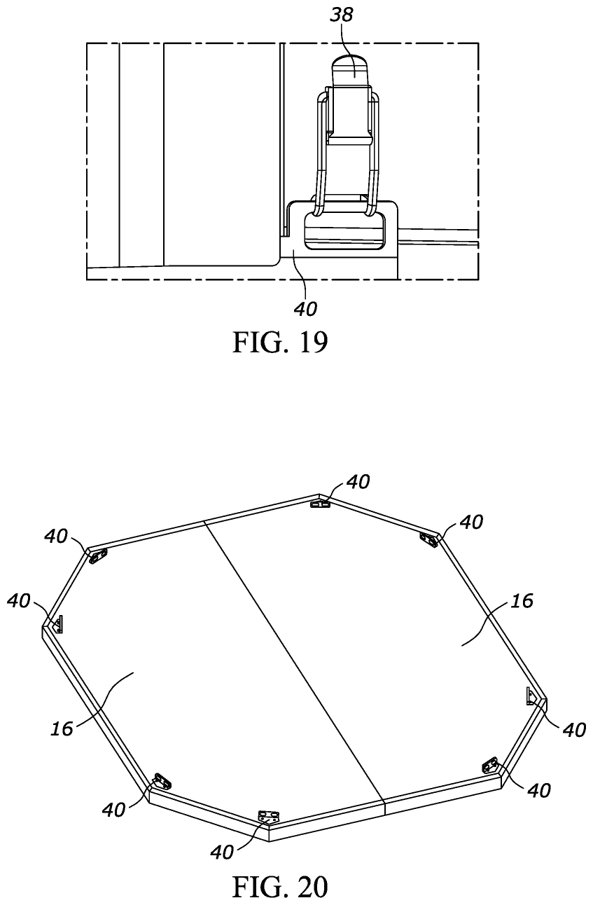

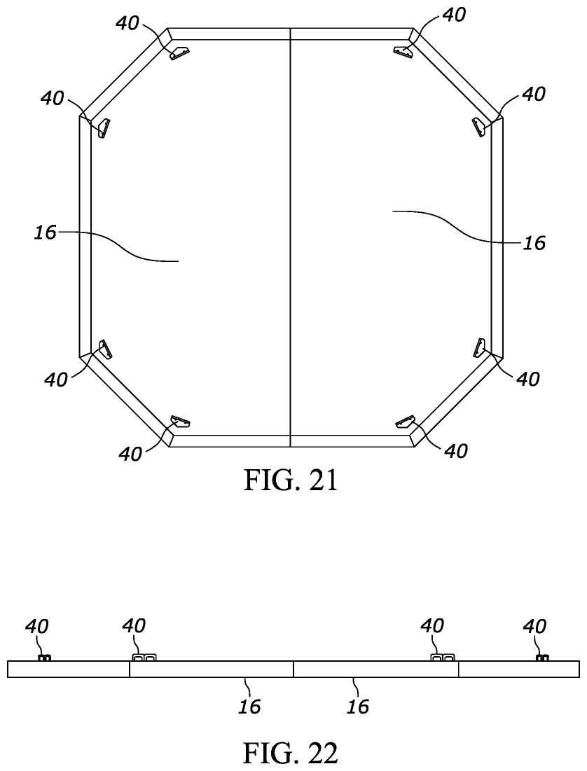

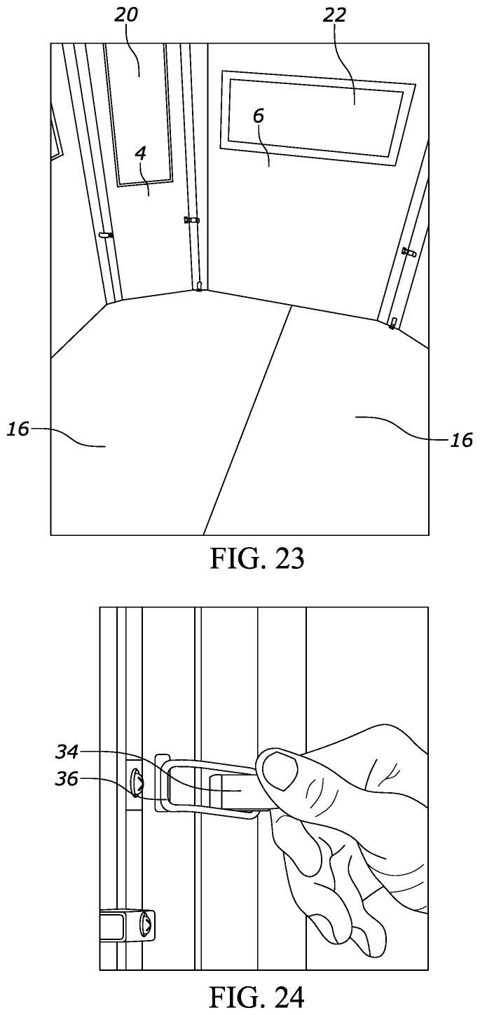

FIGS. 9-24 show various interior views of the hunting blind 2. FIG. 9 shows the different forms of panel attachment in the present embodiment. When assembled, a top latch 30 mates to a corresponding top latch mating element 32, one or more side latches 34 mate to respective corresponding side latch mating elements 36, and a bottom latch 38 mates to a corresponding bottom latch mating element 40.

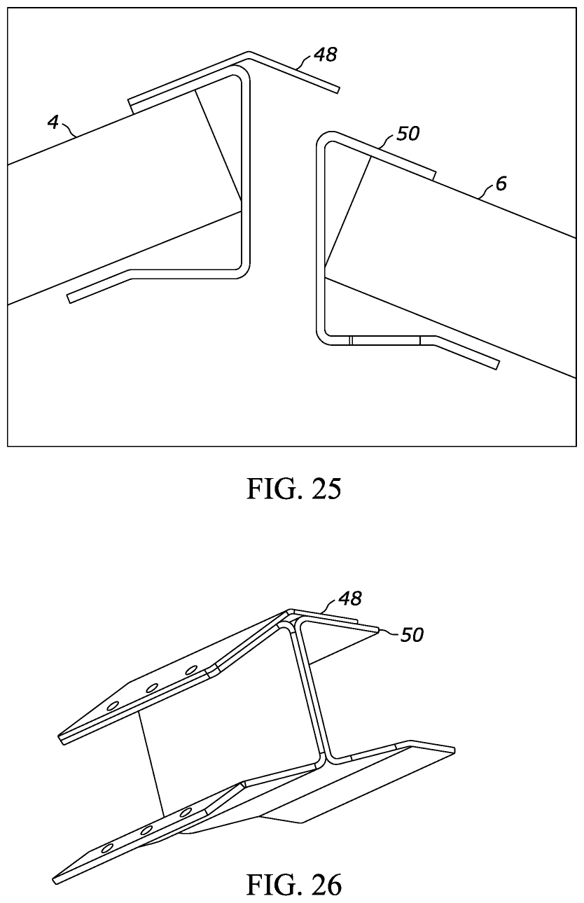

As shown in FIG. 9, and in greater detail in FIGS. 10-12 and 24, each side panel 4, 6 in this embodiment includes a first connecting flange 42, to which is attached at least one side latch 34, and a second connecting flange 44 on a side opposite the first connecting flange 42, each second connecting flange 44 including a side latch mating element 36. In this embodiment, the side latch mating element is an edge 46 of an interior opening formed in the second connecting flange 44. In other embodiments, other forms of latches and other mating elements capable of mating with the chosen latch may be used. Thus, for example, in FIG. 9, the first connecting flange 42 of the narrower side panel 4 connects to the second connecting flange 44 of the adjacent wider side panel 6. The unique latch connection makes the modular panels easy to assemble and disassemble without the need to transport extra tools and small parts, such as bolts and nuts or screws, to the hunting site and then up to the top of the base where the blind is assembled. Additionally, the side panels 4,6 include coinciding overlapping elements 48, 50, that overlap with one another when side panels 4,6 are arranged in an assembled position to eliminate the generation of a single seam through which direct airflow may enter or exit the hunting blind. The shape of the overlapping elements 48, 50 is shown in detail in FIG. 25 (prior to assembly) and FIG. 26 (in assembled positions). This helps to eliminate cold drafts and maintain warmth inside the hunting blind.

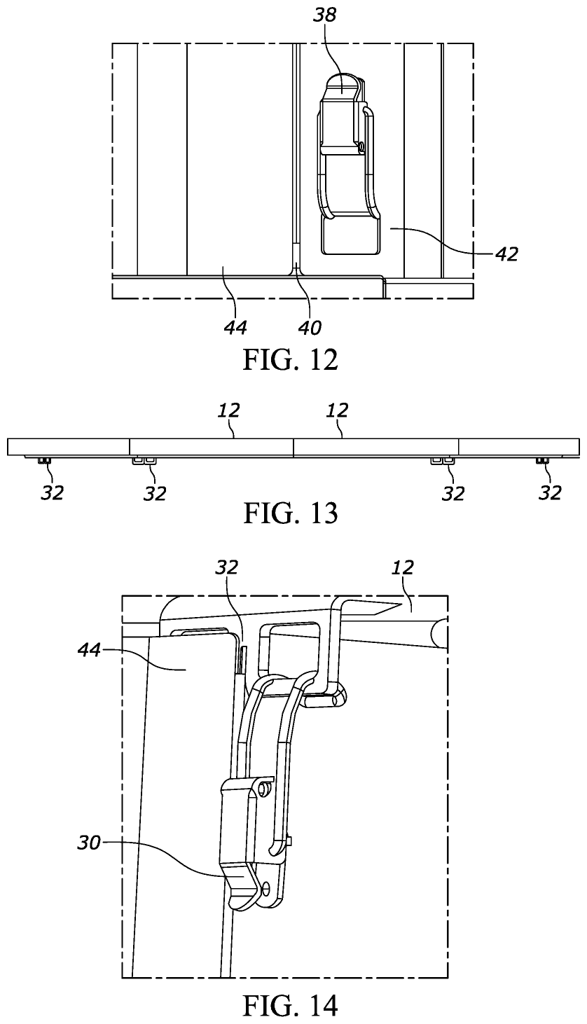

FIGS. 10 and 13-17 illustrate the connection between the side panels 4,6 and the top panels 12. At each connection point, a top latch mating element 32 protrudes from at least one of the top panels. A top latch 30, attached to the first connecting flange 42, can extend through an opening formed in the first connecting flange 42 and mate with the top latch mating element 32. FIGS. 12 and 18-22 show the connection between the side panels 4,6 and the bottom panels 16. At each connection point, a bottom latch mating element 40 protrudes from at least one of the bottom panels 16. A bottom latch 38, attached to the first connecting flange 42, can extend through an opening formed in the first connecting flange 42 and mating with the bottom latch mating element 40.

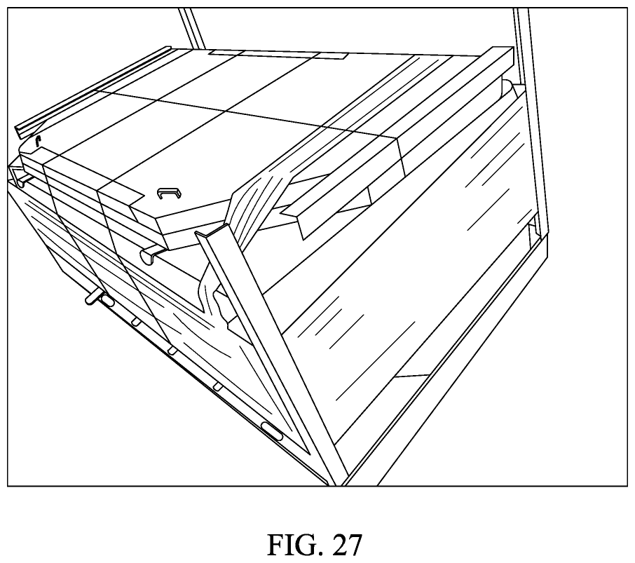

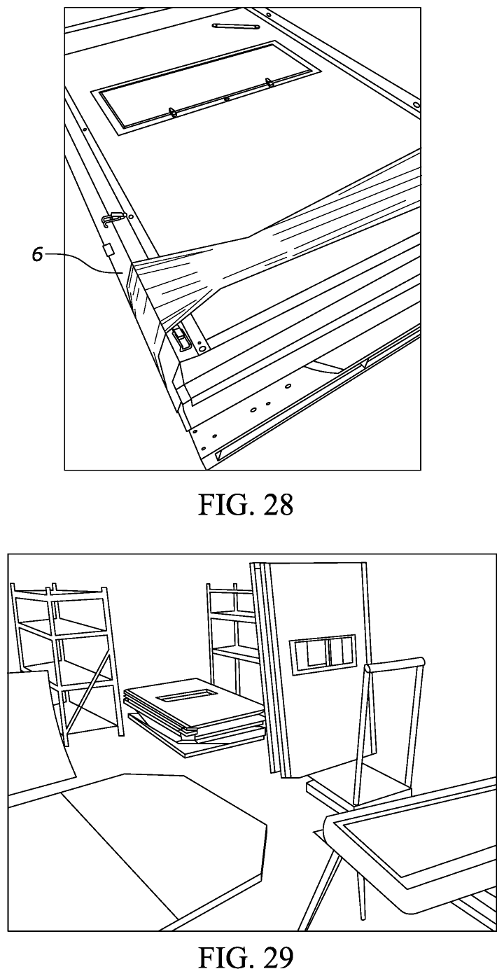

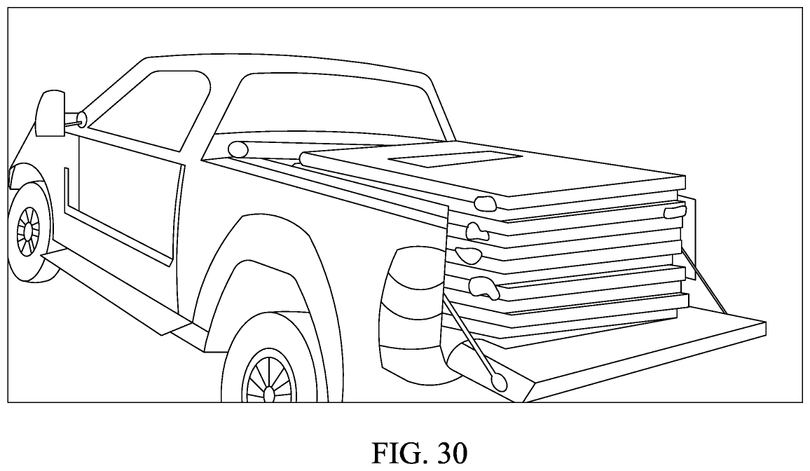

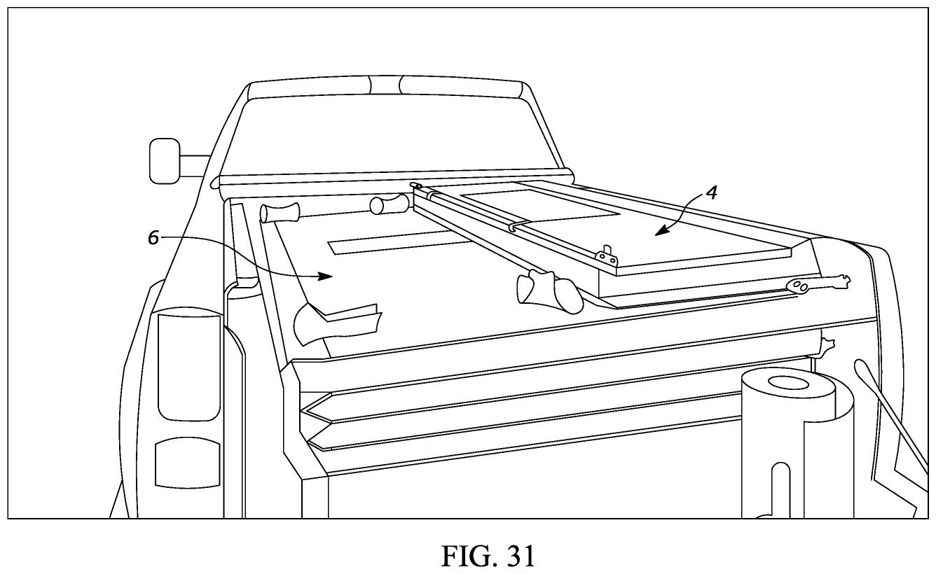

FIGS. 27-31 show various views of an embodiment of the modular hunting blind 2 in disassembled form. As can be seen in particular in FIGS. 30-31, the individual pieces, when stacked together and positioned lengthwise, are sized to fit within the bed of a standard pickup truck. Along with the elimination of the need for an additional tool bag, the sizing of the panels 4, 6, 12, 16 also eliminates the need for an additional trailer or rack to transport the blind to the hunting location if the user owns or has access to a standard pickup truck.

Although the invention has been herein described in what is perceived to be the most practical and preferred embodiments, it is to be understood that the invention is not intended to be limited to the specific embodiments set forth above. Rather, it is recognized that modifications may be made by one of skill in the art of the invention without departing from the spirit or intent of the invention and, therefore, the invention is to be taken as including all reasonable equivalents to the subject matter of the appended claims and the description of the invention herein.

What is claimed is:

1. A hunting blind comprising:
a first panel having a first panel body and a first connecting flange attached to the first panel body;
a second panel having a second panel body and a second connecting flange attached to the second panel body;
a latch attached to the first panel; and
a latch mating element attached to the second panel, the latch configured to mate with the latch mating element when the first panel is positioned adjacent to the second panel.

2. The hunting blind of claim 1 wherein the latch is attached to the first panel on the first connecting flange.

3. The hunting blind of claim 2 wherein the latch mating element is attached to the second panel on the second connecting flange.

4. The hunting blind of claim 1 further comprising:
a second latch attached to the first panel; and
a second latch mating element attached to the second panel, the second latch configured to mate with the second latch mating element when the first panel is positioned adjacent to the second panel.

5. The hunting blind of claim 4 wherein the second latch is attached to the first panel on the first connecting flange.

6. The hunting blind of claim 5 wherein the second latch mating element is attached to the second panel on the second connecting flange.

7. The hunting blind of claim 1 wherein the first panel and the second panel have overlapping portions thereof when positioned adjacent to each other.

8. The hunting blind of claim 4 wherein the first panel and the second panel have overlapping portions thereof when positioned adjacent to each other.

9. A hunting blind comprising:
a side panel having a top latch attached thereto;
a top panel having a top latch mating element attached thereto, the top latch configured to mate with the top latch mating element when the top panel is positioned adjacent the side panel.

10. A hunting blind comprising:
a plurality of side panels, each of said side panels having at least one latch or at least one latch mating element attached thereto, wherein each of the at least one latches corresponds to one of the at least one latch mating elements;
at least one of the plurality of side panels having a top latch attached thereto; and
at least one top panel having a top latch mating element attached thereto, the top latch configured to mate with the top latch mating element when the top panel is positioned adjacent the at least one of the plurality of side panels.
